(19) United States
(12) Patent Application Publication
(10) Pub. No.: US 2026/0066463 A1
(43) Pub. Date: Mar. 5, 2026

(54) INGREDIENT FOR SECONDARY CELL SEPARATOR COATING MATERIAL, SECONDARY CELL SEPARATOR COATING MATERIAL, SECONDARY CELL SEPARATOR, AND SECONDARY CELL

(71) Applicant: MITSUI CHEMICALS, INC., Chuo-ku, Tokyo (JP)

(72) Inventors: Tsuyoshi YAMAGUCHI, Ichihara-shi, Chiba (JP); Yoshihiko TOMITA, Ichihara-shi, Chiba (JP); Yasuyuki KAGAWA, Ichihara-shi, Chiba (JP)

(73) Assignee: MITSUI CHEMICALS, INC., Chuo-ku, Tokyo (JP)

(21) Appl. No.: 19/107,251

(22) PCT Filed: Nov. 24, 2023
(86) PCT No.: PCT/JP2023/042100

§ 371 Date: Feb. 27, 2025

(30) Foreign Application Priority Data
Dec. 1, 2022 (JP) 2022-192774
Feb. 16, 2023 (JP) 2023-022373

(51) Int. Cl. H01M 50/446; H01M 10/0525; H01M 50/414; H01M 50/431; H01M 50/443; H01M 50/449

(52) U.S. Cl. CPC H01M 50/446; H01M 10/0525; H01M 50/414; H01M 50/431; H01M 50/443; H01M 50/449

(57) ABSTRACT

An ingredient for a secondary cell separator coating material includes a resin which is a reaction product of a modified methylolmelamine condensation resin having an acid group and polyvinyl alcohol, or the modified methylolmelamine condensation resin having the acid group and the polyvinyl alcohol.

### TECHNICAL FIELD

The present invention relates to an ingredient for a secondary cell separator coating material, a secondary cell separator coating material, a secondary cell separator, and a secondary cell, to be specific, to an ingredient for a secondary cell separator coating material, a secondary cell separator coating material including the ingredient for a secondary cell separator coating material, a secondary cell separator including a coating film of the secondary cell separator coating material, and a secondary cell including the secondary cell separator.

### BACKGROUND ART

Conventionally, a secondary cell is equipped with a separator for separating a positive electrode from a negative electrode, and allowing ions in an electrolytic solution to pass through.

As such a separator, for example, a polyolefin porous film has been known.

On the other hand, a coating layer may be provided on the surface of the separator in order to impart various properties. Such a coating layer is formed, for example, by coating a secondary cell separator coating material onto the surface of the separator and drying the coating material.

As such a secondary cell separator coating material, for example, a secondary cell separator coating material containing an ingredient for a secondary cell separator coating material containing a water-soluble polymer obtained by polymerizing a water-soluble polymer raw material containing methacrylamide and methacrylic acid, and an inorganic filler has been proposed (ref: for example, Patent Document 1).

### CITATION LIST

### Patent Document

Patent Document 1: Japanese Unexamined Patent Publication No. 2021-103676

### SUMMARY OF THE INVENTION

### Problem to be Solved by the Invention

On the other hand, when the separator changes its shape due to shrinkage by heat, a short circuit may occur between the positive electrode and the negative electrode. Therefore, heat resistance is required for the coating layer.

The present invention provides an ingredient for a secondary cell separator coating material having excellent heat resistance and excellent ion permeability, a secondary cell separator coating material including the ingredient for a secondary cell separator coating material, a secondary cell separator including a coating film of the secondary cell separator coating material, and a secondary cell including the secondary cell separator.

### Means for Solving the Problem

The present invention [1] includes an ingredient for a secondary cell separator coating material including a resin being a reaction product of a modified methylolmelamine condensation resin having an acid group and polyvinyl alcohol, or the modified methylolmelamine condensation resin having the acid group and the polyvinyl alcohol.

The present invention [2] includes the ingredient for a secondary cell separator coating material described in the above-described [1] including the resin, wherein the acid group is a sulfonic acid group.

The present invention [3] includes the ingredient for a secondary cell separator coating material described in the above-described [1] including the modified methylolmelamine condensation resin having the acid group and the polyvinyl alcohol, wherein a content ratio of the polyvinyl alcohol is 5 parts by mass or more and below 50 parts by mass with respect to 100 parts by mass of the modified methylolmelamine condensation resin.

The present invention [4] includes a secondary cell separator coating material including the ingredient for a secondary cell separator coating material described in any one of the above-described [1] to [3] and inorganic particles.

The present invention [5] includes a secondary cell separator including a porous film and a coating film of the secondary cell separator coating material described in the above-described [4] disposed on at least one surface of the porous film.

The present invention [6] includes a secondary cell including a positive electrode, a negative electrode, and the secondary cell separator described in the above-described [5] disposed between the positive electrode and the negative electrode.

### Effect of the Invention

The ingredient for a secondary cell separator coating material of the present invention includes the resin which is the reaction product of the modified methylolmelamine condensation resin having the acid group and the polyvinyl alcohol, or the modified methylolmelamine condensation resin having the acid group and the polyvinyl alcohol. Therefore, heat resistance and ion permeability are excellent.

The secondary cell separator coating material of the present invention includes the ingredient for a secondary cell separator coating material of the present invention. Therefore, the heat resistance and the ion permeability are excellent.

The secondary cell separator of the present invention includes the coating film of the secondary cell separator coating material of the present invention. Therefore, the heat resistance and the ion permeability are excellent.

The secondary cell of the present invention includes the secondary cell separator of the present invention. Therefore, the heat resistance and the ion permeability are excellent.

### DESCRIPTION OF EMBODIMENTS

An ingredient for a secondary cell separator coating material includes a resin which is a reaction product of a modified methylolmelamine condensation resin having an acid group and polyvinyl alcohol, or the modified methylolmelamine condensation resin having the acid group and the polyvinyl alcohol. Hereinafter, a first invention and a second invention are described in detail in order. In the first invention, the ingredient for a secondary cell separator coating material includes the resin which is the reaction product of the modified methylolmelamine condensation resin having the acid group and the polyvinyl alcohol. In the second invention, the ingredient for a secondary cell separator coating material includes the modified methylolmelamine condensation resin having the acid group and the polyvinyl alcohol.

### 1. Ingredient for Secondary Cell Separator Coating Material

### <<First Invention>>

The ingredient for a secondary cell separator coating material includes the resin which is the reaction product of the modified methylolmelamine condensation resin having the acid group and the polyvinyl alcohol.

The resin is the reaction product of the modified methylolmelamine condensation resin having the acid group and the polyvinyl alcohol.

### <Modified Methylolmelamine Condensation Resin Having Acid Group>

The modified methylolmelamine condensation resin having the acid group (hereinafter, may be referred to as a modified methylolmelamine condensation resin) is a condensation polymer of a modified methylolmelamine.

The modified methylolmelamine is the reaction product of methylolmelamine and an acid component.

### [Methylolmelamine]

The methylolmelamine is the reaction product of melamine and formaldehyde or paraformaldehyde. When the paraformaldehyde is used, the paraformaldehyde is hydrolyzed into the formaldehyde to be then reacted with the melamine.

In order to react the melamine and the formaldehyde, water, the melamine, and the formaldehyde are mixed and heated.

Although the details are described later, a mixing amount of the formaldehyde is, from the viewpoint of increasing a molecular weight, for example, 3.0 or more, preferably above 3.0, more preferably 3.2 or more, further more preferably 3.3 or more, and for example, 5.0 or less, preferably 4.0 or less with respect to 1 mol of the melamine.

As heating conditions, a heating temperature is, for example, 40° C. or more, preferably 50° C. or more, and for example, 90° C. or less, preferably 80° C. or less. Further, the heating time is, for example, 0.5 hours or more, preferably 2 hours or more, and for example, 6 hours or less.

In addition, in the above-described reaction, a pH is 3.0 or more, preferably 4.0 or more, more preferably 8.0 or more, further more preferably 9.0 or more, particularly preferably 10.0 or more, and for example, 13.0 or less, preferably 12.0 or less, more preferably 11.8 or less. The pH can be adjusted by adding alkali (for example, sodium hydroxide).

Thus, the melamine (the following general formula (1-1)) and the formaldehyde (the following general formula (1-2)) react with each other, thereby obtaining the methylolmelamine (the following general formula (1-3)).

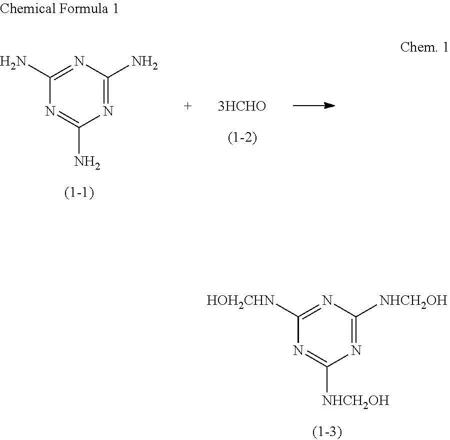

Preferably, the methylolmelamine (the above-described general formula (1-3)) is a trimethylolmelamine in which three of six hydrogens in an amino group of the melamine are modified into a methylol group, or the methylolmelamine is a tetramethylolmelamine in which four of six hydrogens in the amino group of the melamine are modified into the methylol group.

### [Modified Methylolmelamine]

As described above, the modified methylolmelamine is the reaction product of the methylolmelamine and the acid component.

The acid component is a component capable of reacting with the methylol group of the methylolmelamine. Then, the acid component is the component for introducing the acid group into the methylolmelamine by reacting with the methylol group of the methylolmelamine.

Examples of the acid component include carboxylic acid, phosphoric acid, and sulfite.

Examples of the carboxylic acid include maleic acid, succinic acid, phthalic acid, formylbenzoic acid, aminobenzoic acid, acrylic acid, methacrylic acid, and amino acid (for example, glycine). Further, examples of the carboxylic acid include salts and anhydrides thereof. Examples of the salt of the carboxylic acid include sodium maleate and sodium succinate. Examples of the anhydride of the carboxylic acid include maleic anhydride, succinic anhydride, and phthalic anhydride.

Examples of the phosphoric acid include phosphonobenzoic acid and aminophenylphosphonic acid. Further, examples of the phosphoric acid include salts thereof. An example of the salt of the phosphoric acid includes sodium phosphonobenzoate.

Examples of the sulfite include sulfobenzoic acid, formylbenzenesulfonic acid, sulfanilic acid, pyrosulfite, and sulfite. Examples of the sulfite include salts thereof. Examples of the salt of the sulfite include sodium bisulfite, sodium sulfite, and sodium pyrosulfite. As the sulfite, preferably, sodium bisulfite, sulfanilic acid, and sodium pyrosulfite are used. As the sulfite, more preferably, sodium bisulfite is used.

As the acid component, preferably, sulfite is used.

These acid components may be used alone or in combination of two or more.

Then, the modified methylolmelamine is obtained by reacting the methylolmelamine with the acid component.

In order to react the methylolmelamine with the acid component, the water, the methylolmelamine, and the acid component are mixed and heated.

The mixing amount of the acid component is, for example, 0.44 mol or more, preferably 0.50 mol or more, more preferably 0.60 mol or more, further more preferably 0.70 mol or more, and for example, 1.00 mol or less, preferably 0.90 mol or less, more preferably 0.80 mol or less with respect to 1 mol of the methylolmelamine.

As the heating conditions, the heating temperature is, for example, 50° C. or more, preferably 70° C. or more, and for example, 100° C. or less, preferably 90° C. or less. Further, the heating time is, for example, 0.5 hours or more, preferably 1 hour or more, and for example, 6 hours or less.

Thus, the methylolmelamine and the acid component react with each other, thereby obtaining the modified methylolmelamine. Specifically, one of the methylol groups in the methylolmelamine can be modified into the acid group derived from the acid component by the acid component.

In other words, the modified methylolmelamine has the acid group derived from the acid component. Specifically, when the acid component is the carboxylic acid, the modified methylolmelamine has a carboxyl group as the acid group. In addition, when the acid component is the phosphoric acid, the modified methylolmelamine has a phosphate group as the acid group. In addition, when the acid component is the sulfite, the modified methylolmelamine has a sulfonic acid group as the acid group. As the acid group, preferably, a sulfonic acid group is used.

More specifically, when the acid component is the sodium bisulfite, the methylolmelamine (the following general formula (1-3)) reacts with the sodium bisulfite (the following general formula (2-1)), thereby obtaining the modified methylolmelamine (the following general formula (2-2)). The modified methylolmelamine represented by the following general formula (2-2) has the sulfonic acid group as the acid group.

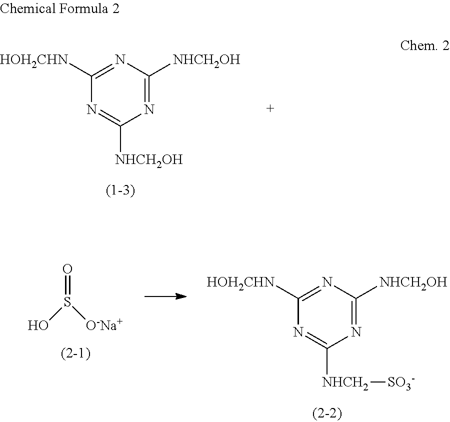

As the modified methylolmelamine, preferably, a modified methylolmelamine represented by the above-described general formula (2-2) is used.

Then, as described above, the modified methylolmelamine condensation resin is the condensation polymer of the modified methylolmelamine (modified methylolmelamine having the acid group). A method for producing the modified methylolmelamine condensation resin is described later.

### <Polyvinyl Alcohol>

The polyvinyl alcohol is a component for imparting wettability and improving adhesion when the resin is used as the ingredient for a secondary cell separator coating material.

Examples of the polyvinyl alcohol include unmodified polyvinyl alcohol and modified polyvinyl alcohol.

Examples of the modified polyvinyl alcohol include anionic group-modified polyvinyl alcohol (for example, carboxyl group-modified polyvinyl alcohol, sulfo group-modified polyvinyl alcohol), and hydrophobic group-modified polyvinyl alcohol. As the modified polyvinyl alcohol, preferably, anionic group-modified polyvinyl alcohol is used. As the modified polyvinyl alcohol, more preferably, carboxyl group-modified polyvinyl alcohol is used.

As the polyvinyl alcohol, preferably, modified polyvinyl alcohol is used.

A saponification degree of the polyvinyl alcohol is, for example, 70 mol % or more, preferably 85 mol % or more, more preferably 90 mol % or more, further more preferably 95 mol % or more, and for example, 100 mol % or less, preferably 99 mol % or less.

The polyvinyl alcohol may be used alone or in combination of two or more.

Further, the polyvinyl alcohol can be also prepared as an aqueous solution of the polyvinyl alcohol. In the aqueous solution of the polyvinyl alcohol, the solid content concentration of the polyvinyl alcohol is, for example, 5% by mass or more, and for example, 50% by mass or less.

### <Production Method of Resin>

The resin is obtained by reacting the modified methylolmelamine condensation resin with the polyvinyl alcohol.

Specifically, the resin is obtained by producing the modified methylolmelamine condensation resin by dehydrating and condensing the modified methylolmelamine, and also by reacting the modified methylolmelamine condensation resin with the polyvinyl alcohol. In other words, such a resin is distinguished from a resin obtained by first obtaining the modified methylolmelamine condensation resin by dehydrating and condensing the modified methylolmelamine, and thereafter, by reacting the obtained resin with the vinyl alcohol.

Specifically, first, the modified methylolmelamine and the polyvinyl alcohol are blended into the water. Next, the modified methylolmelamine is dehydrated and condensed, and the modified methylolmelamine condensation resin obtained by the dehydration and condensation is reacted with the polyvinyl alcohol.

In the above-described dehydration and condensation, the modified methylolmelamine condensation resin is obtained by dehydrating and condensing the two methylol groups in the modified methylolmelamine.

In addition, in the reaction of the modified methylolmelamine condensation resin with the polyvinyl alcohol, the methylol group of the modified methylolmelamine condensation resin and the hydroxyl group of the polyvinyl alcohol react with each other. The reaction of the methylol group and the hydroxyl group is, for example, described in Journal of Cleaner Production Volume 255, 10 May 2020, 120062, “Efficient removal of Congo red dye from aqueous solution by adsorbent films of polyvinyl alcohol/melamine-formaldehyde composite and bactericidal effects”.

In addition, in this reaction, for example, an acid (for example, sulfuric acid) is added, and the mixture is heated at the pH of 5 or more and below 8 in the water.

As the heating conditions, the heating temperature is, for example, 50° C. or more, preferably 60° C. or more, and for example, 90° C. or less, preferably 80° C. or less. Further, the heating time is, for example, 1 hour or more, preferably 2 hours or more, and for example, 6 hours or less.

A mixing ratio of the modified methylolmelamine is, for example, 70 parts by mass or more, preferably 80 parts by mass or more, more preferably 85 parts by mass or more, and for example, 99 parts by mass or less, preferably 95 parts by mass or less with respect to 100 parts by mass of the total amount of the modified methylolmelamine and the polyvinyl alcohol.

In addition, the mixing ratio of the polyvinyl alcohol is, for example, 1 part by mass or more, preferably 5 parts by mass or more, and for example, 30 parts by mass or less, preferably 20 parts by mass or less, more preferably 15 parts by mass or less with respect to 100 parts by mass of the total amount of the modified methylolmelamine and the polyvinyl alcohol.

As described above, the modified methylolmelamine condensation resin and the polyvinyl alcohol react, thereby obtaining the resin (aqueous solution of the resin).

The reaction from the melamine to the resin described above can be carried out continuously or dividedly.

In the aqueous solution of the resin, the solid content concentration of the modified methylolmelamine condensation resin is, for example, 10% by mass or more, preferably 15% by mass or more, and for example, 40% by mass or less.

Such a resin has the same acid group as the modified methylolmelamine.

In the above-described description, the methylolmelamine and the acid component are reacted, thereby obtaining the modified methylolmelamine. Next, the modified methylolmelamine condensation resin is obtained by the dehydration and condensation of the modified methylolmelamine. All of the methylolmelamine may not react with the acid component according to a mixing amount of the acid component, and the methylolmelamine may remain. In such a case, the three methylol groups in the methylolmelamine and the two methylol groups of the modified methylolmelamine are condensed.

The resin is the reaction product of the modified methylolmelamine condensation resin having the acid group and the polyvinyl alcohol. Therefore, heat resistance, ion permeability, and storage stability are excellent.

Then, the ingredient for a secondary cell separator coating material includes the above-described resin (aqueous solution of the above-described resin).

In addition, if necessary, an additive may be blended into the ingredient for a secondary cell separator coating material at an appropriate ratio. Examples of the additive include wetting agents, dispersants, hydrophilic resins, moistening agents, defoaming agents, and pH adjusters. In other words, the ingredient for a secondary cell separator coating material includes the additive if necessary. The additive may be blended at the time of production and/or after the production of the resin described above.

On the other hand, since the ingredient for a secondary cell separator coating material includes the resin obtained by using the polyvinyl alcohol, the wettability is excellent. Therefore, the ingredient for a secondary cell separator coating material has the excellent wettability, even if it does not include the wetting agent. In other words, the ingredient for a secondary cell separator coating material preferably includes the above-described resin and does not include the wetting agent.

In the ingredient for a secondary cell separator coating material, the solid content concentration of the above-described resin is, for example, 10% by mass or more, preferably 15% by mass or more, and for example, 40% by mass or less.

The ingredient for a secondary cell separator coating material includes the above-described resin. Therefore, the heat resistance, the ion permeability, and the storage stability are excellent.

### <<Second Invention>>

The ingredient for a secondary cell separator coating material includes the modified methylolmelamine condensation resin having the acid group and the polyvinyl alcohol.

### <Modified Methylolmelamine Condensation Resin Having Acid Group>

The modified methylolmelamine condensation resin having the acid group is the same as the modified methylolmelamine condensation resin having the acid group in the first invention. In other words, the modified methylolmelamine condensation resin having the acid group is the condensation polymer of the modified methylolmelamine. The modified methylolmelamine is the reaction product of the methylolmelamine and the acid component.

The methylolmelamine is the reaction product of the melamine and the formaldehyde.

The mixing amount of the formaldehyde is, for example, 2.4 mol or more, preferably 2.6 mol or more, more preferably 2.8 mol or more, further more preferably 2.9 mol or more, and for example, 5.0 or less, preferably 4.0 or less, more preferably 3.3 mol or less, further more preferably 3.1 mol or less with respect to 1 mol of the melamine.

When the mixing amount of the formaldehyde with respect to 1 mol of the melamine is the above-described lower limit or more and the above-described upper limit or less, almost all of the three amino groups in the melamine can be modified into the methylol group.

In addition, in the reaction of the melamine and the formaldehyde, the heating temperature, the heating time, and the pH are the same as those of the first invention.

As the methylolmelamine, preferably, a trimethylolmelamine in which all of the three amino groups in the melamine are modified into the methylol group is used.

Further, as described above, the modified methylolmelamine is the reaction product of the methylolmelamine and the acid component.

Examples of the acid component include the acid components described in the first invention. As the acid component, preferably, a sulfite is used.

These acid components may be used alone or in combination of two or more.

Then, the modified methylolmelamine is obtained by reacting the methylolmelamine with the acid component in the same manner as the first invention. Specifically, in order to react the methylolmelamine with the acid component, the water, the methylolmelamine, and the acid component are mixed and heated.

The mixing amount of the acid component is, for example, 0.10 mol or more, preferably 0.15 mol or more, more preferably 0.30 mol or more, further more preferably 0.40 mol or more, particularly preferably 0.43 mol or more, and for example, below 0.70 mol, preferably 0.65 mol or less, more preferably 0.60 mol or less, further more preferably 0.50 mol or less with respect to 1 mol of the methylolmelamine.

The heating conditions are the same as those of the first invention.

Thus, the methylolmelamine and the acid component react with each other, thereby obtaining the modified methylolmelamine. Specifically, one of the methylol groups in the methylolmelamine can be modified into the acid group derived from the acid component by the acid component. As the acid group, preferably, a sulfonic acid is used.

Then, as described above, the modified methylolmelamine condensation resin having the acid group is the condensation polymer of the modified methylolmelamine (modified methylolmelamine having the acid group).

In order to condense and polymerize the modified methylolmelamine, for example, the modified methylolmelamine is heated in the water at the pH of 5 or more and below 8 by adding the acid (for example, sulfuric acid).

As the heating conditions, the heating temperature is, for example, 50° C. or more, preferably 60° C. or more, and for example, 90° C. or less, preferably 80° C. or less. Further, the heating time is, for example, 1 hour or more, preferably 2 hours or more, and for example, 6 hours or less.

Thereafter, alkali (for example, sodium hydroxide) is added, thereby adjusting the pH to, for example, 11 or more and 13 or less. Thus, the condensation polymerization reaction is stopped.

As described above, the two methylol groups in the modified methylolmelamine are dehydrated and condensed, thereby obtaining the modified methylolmelamine condensation resin (aqueous dispersion liquid of the modified methylolmelamine condensation resin).

The reaction from the melamine to the modified methylolmelamine condensation resin described above can be carried out continuously or dividedly.

In the aqueous dispersion liquid of the modified methylolmelamine condensation resin, the solid content concentration of the modified methylolmelamine condensation resin is, for example, 10% by mass or more, preferably 15% by mass or more, and for example, 40% by mass or less.

Such a modified methylolmelamine condensation resin has the same acid group as that of the modified methylolmelamine.

The content ratio of the modified methylolmelamine condensation resin is, for example, 60 parts by mass or more, preferably 70 parts by mass or more, more preferably 80 parts by mass or more, and for example, 98 parts by mass or less, preferably 90 parts by mass or less with respect to 100 parts by mass of the total amount of the modified methylolmelamine condensation resin and the polyvinyl alcohol.

In the above-described description, the methylolmelamine and the acid component are reacted, thereby obtaining the modified methylolmelamine. Next, the modified methylolmelamine condensation resin is obtained by the dehydration and condensation of the modified methylolmelamine. All of the methylolmelamines may not react with the acid component and the methylolmelamine may remain according to the mixing amount of the acid component. In such a case, the three methylol groups in the methylolmelamine and the two methylol groups of the modified methylolmelamine are condensed.

### <Polyvinyl Alcohol>

An example of the polyvinyl alcohol includes the polyvinyl alcohol described in the first invention. As the polyvinyl alcohol, preferably, anionic group-modified polyvinyl alcohol is used. As the modified polyvinyl alcohol, more preferably, carboxyl group-modified polyvinyl alcohol is used.

The saponification degree of the polyvinyl alcohol is the same as that of the first invention.

The polyvinyl alcohol may be used alone or in combination of two or more.

The content ratio of the polyvinyl alcohol is, for example, 3 parts by mass or more, preferably, from the viewpoint of improving the heat resistance, 5 parts by mass or more, more preferably 6 parts by mass or more, further more preferably 10 parts by mass or more, and for example, 60 parts by mass or less, preferably, from the viewpoint of improving the heat resistance and the ion permeability, below 50 parts by mass, more preferably 40 parts by mass or less, further more preferably 30 parts by mass or less, particularly preferably 20 parts by mass or less with respect to 100 parts by mass of the modified methylolmelamine condensation resin.

In addition, the content ratio of the polyvinyl alcohol is, for example, 2 parts by mass or more, preferably, from the viewpoint of improving the heat resistance, 10 parts by mass or more, and for example, 40 parts by mass or less, preferably, from the viewpoint of improving the heat resistance and the ion permeability, 30 parts by mass or less, more preferably 20 parts by mass or less with respect to 100 parts by mass of the total amount of the modified methylolmelamine condensation resin and the polyvinyl alcohol.

Further, the polyvinyl alcohol can be also prepared as the aqueous solution of the polyvinyl alcohol. In the aqueous solution of the polyvinyl alcohol, the solid content concentration of the polyvinyl alcohol is, for example, 5% by mass or more, and for example, 50% by mass or less.

### <Preparation of Ingredient for Secondary Cell Separator Coating Material>

The ingredient for a secondary cell separator coating material is prepared as a package in which the modified methylolmelamine condensation resin having the acid group (aqueous dispersion liquid of the modified methylolmelamine condensation resin) and the polyvinyl alcohol are independently provided. Then, these are blended at the time of its use.

In addition, if necessary, the additive may be blended into the ingredient for a secondary cell separator coating material at an appropriate ratio. Examples of the additive include wetting agents, dispersants, hydrophilic resins, moistening agents, defoaming agents, and pH adjusters. In other words, the ingredient for a secondary cell separator coating material includes the additive if necessary. The additive may be blended into the modified methylolmelamine condensation resin having the acid group and/or the polyvinyl alcohol.

On the other hand, since the ingredient for a secondary cell separator coating material includes the modified methylolmelamine condensation resin having the acid group and the polyvinyl alcohol, the wettability is excellent. Therefore, the ingredient for a secondary cell separator coating material has the excellent wettability, even if it does not include the wetting agent. In other words, the ingredient for a secondary cell separator coating material preferably includes the modified methylolmelamine condensation resin having the acid group and the polyvinyl alcohol and does not include the wetting agent.

Since the ingredient for a secondary cell separator coating material includes the modified methylolmelamine condensation resin having the acid group and the polyvinyl alcohol, the heat resistance and the ion permeability are excellent.

Then, such an ingredient for a secondary cell separator coating material (the first invention and the second invention), among all, can be preferably used as the ingredient for a secondary cell separator coating material.

In the following, the secondary cell separator coating material obtained by using the ingredient for a secondary cell separator coating material is described in detail.

### 2. Secondary Cell Separator Coating Material

The secondary cell separator coating material includes the above-described ingredient for a secondary cell separator coating material and inorganic particles.

Examples of the inorganic particles include oxides, nitrides, carbides, sulfates, hydroxides, and potassium titanate. Examples of the oxide include alumina, silica, titania, zirconia, magnesia, ceria, yttria, zinc oxide, and iron oxide. Examples of the nitride include silicon nitride, titanium nitride, and boron nitride. Examples of the carbide include silicon carbide and calcium carbonate. Examples of the sulfate include magnesium sulfate and aluminum sulfate. Examples of the hydroxide include aluminum hydroxide and aluminum hydroxide oxide. Examples of the silicate include talc, kaolinite, dickite, nacrite, halloysite, pyrophyllite, montmorillonite, sericite, mica, amesite, bentonite, asbestos, zeolite, calcium silicate, magnesium silicate, diatomaceous earth, silica sand, and glass.

As the inorganic particles, preferably, a hydroxide is used. As the inorganic particles, more preferably, an aluminum hydroxide oxide is used.

An average median diameter D50 of the inorganic particles is, for example, 0.1 μm or more, preferably 0.5 μm or more, and for example, 5 μm or less, preferably 1 μm or less.

These inorganic particles may be used alone or in combination of two or more.

The mixing ratio of the inorganic particles are described later.

Then, in order to produce the secondary cell separator coating material, first, the inorganic particles and, if necessary, a dispersant are blended into the water, thereby preparing the aqueous dispersion liquid of the inorganic particles. When the dispersant is blended, the secondary cell separator coating material includes the dispersant.

Examples of the dispersant include ammonium polycarboxylate and sodium polycarboxylate. As the dispersant, preferably, an ammonium polycarboxylate is used.

The mixing ratio of the dispersant (solid content) is, for example, 0.1 parts by mass or more, preferably 0.5 parts by mass or more, and for example, 10 parts by mass or less, preferably 3 parts by mass or less with respect to 100 parts by mass of the inorganic particles.

These dispersants may be used alone or in combination of two or more.

Next, the ingredient for a secondary cell separator coating material (aqueous dispersion liquid of the ingredient for a secondary cell separator coating material) is blended into the aqueous dispersion liquid of the inorganic particles to be stirred.

A stirring method is not particularly limited, and examples thereof include ball mills, bead mills, planetary ball mills, vibrating ball mills, sand mills, colloid mills, attritors, roll mills, high-speed impeller dispersion, stirrer, dispersers, homogenizers, high-speed impact mills, ultrasonic dispersion, and stirring blades.

In addition, if necessary, the above-described additive may be blended into the secondary cell separator coating material at an appropriate ratio. In other words, the secondary cell separator coating material includes, if necessary, the above-described additive. Also, the secondary cell separator coating material preferably does not include the wetting agent.

These additives may be used alone or in combination of two or more.

Thus, the secondary cell separator coating material is obtained. Further, such a secondary cell separator coating material is obtained as the aqueous dispersion liquid dispersed in the water.

The solid content concentration of the aqueous dispersion liquid of the secondary cell separator coating material is, for example, 10% by mass or more, preferably 20% by mass or more, more preferably 30% by mass or more, and for example, 50% by mass or less.

Also, in the secondary cell separator coating material (solid content), the content of the ingredient for a secondary cell separator coating material (solid content) is, for example, 3.0 parts by mass or more, preferably 4.2 parts by mass or more, and 10.0 parts by mass or less, preferably 7.0 parts by mass or less, more preferably 6.0 parts by mass or less with respect to 100 parts by mass of the total amount of the ingredient for a secondary cell separator coating material (solid content) and the inorganic particles. Further, the content of the inorganic particles is 90.0 parts by mass or more, preferably 93.0 parts by mass or more, more preferably 94.0 parts by mass or more, and for example, 97.0 parts by mass or less, preferably 95.8 parts by mass or less with respect to 100 parts by mass of the total amount of the ingredient for a secondary cell separator coating material (solid content) and the inorganic particles.

In addition, in the secondary cell separator coating material (solid content), the content of the ingredient for a secondary cell separator coating material (solid content) is, for example, 3.0 parts by mass or more, preferably 4.0 parts by mass or more, more preferably 4.4 parts by mass or more, and for example, 10.0 parts by mass or less, preferably 7.0 parts by mass or less, more preferably 6.0 parts by mass or less, further more preferably 5.0 parts by mass or less with respect to 100 parts by mass of the total amount of the inorganic particles.

The secondary cell separator coating material includes the ingredient for a secondary cell separator coating material. Therefore, the secondary cell separator including a coating film obtained by using the secondary cell separator coating material has the excellent heat resistance and the excellent ion permeability.

In the following, the secondary cell separator obtained by using the secondary cell separator coating material is described in detail.

### 3. Secondary Cell Separator

The secondary cell separator includes a porous film and the coating film of the secondary cell separator coating material disposed on at least one surface of the porous film.

### [Porous Film]

Examples of the porous film include polyolefin porous films and aromatic polyamide porous films. Examples of the polyolefin porous film include polyethylene porous films and polypropylene porous films. As the porous film, preferably, a polyolefin porous film is used.

A thickness of the porous film is, for example, 1 μm or more, preferably 5 μm or more, and for example, 40 μm or less, preferably 20 μm or less.

### [Coating Film]

The coating film imparts the heat resistance to the porous film. The coating film is made of the secondary cell separator coating material.

The thickness of the coating film is, for example, 1 μm or more, and for example, 10 μm or less, preferably 8 μm or less.

### [Method for Producing Secondary Cell Separator]

A method for producing a secondary cell separator includes a first step of preparing the porous film and a second step of coating the separator coating material onto at least one surface of the porous film.

### (First Step)

In the first step, the porous film is prepared.

### (Second Step)

In the second step, the secondary cell separator coating material is coated onto at least one surface of the porous film, and thereafter, dried if necessary. Thus, the coating film is obtained.

In order to coat the secondary cell separator coating material onto at least one surface of the porous film, first, if necessary, one surface of the porous film is subjected to a surface treatment, and a surface treatment layer is formed on one surface of the porous film. That is, in such a case, the secondary cell separator includes the porous film, the surface treatment layer, and the coating film of the secondary cell separator coating material.

Examples of the surface treatment include corona discharge treatments, glow discharge treatments, plasma treatments, and ozone treatments. In this production method, preferably, from the viewpoint of improving the ion permeability, the surface treatment is not carried out. In other words, the secondary cell separator preferably does not include the surface treatment layer.

A method for coating the secondary cell separator coating material is not particularly limited, and examples thereof include wire bar methods, gravure coating methods, small diameter gravure coating methods, reverse roll coating methods, transfer roll coating method, kiss coating methods, dip coating methods, microgravure coating methods, knife coating methods, air doctor coating methods, blade coating methods, rod coating methods, squeeze coating methods, cast coating methods, die coating methods, screen printing methods, and spray coating methods. As the coating method, preferably, a wire bar method is used.

A drying temperature is, for example, 40° C. or more, and for example, 80° C. or less.

Thus, the secondary cell separator including the porous film, and the coating film of the above-described secondary cell separator coating material disposed on at least one surface of the porous film is produced.

In the above-described description, the coating film of the secondary cell separator coating material is disposed on at least one surface of the porous film. Alternatively, the above-described coating film can be also disposed on both surfaces of the porous film.

The secondary cell separator includes the coating film of the above-described secondary cell separator coating material. Therefore, the secondary cell separator has the excellent heat resistance and the excellent ion permeability. Therefore, the secondary cell separator can be preferably used for the production of the secondary cell.

### 4. Secondary Cell

The secondary cell includes a positive electrode, a negative electrode, the above-described secondary cell separator which is disposed between the positive electrode and the negative electrode, and an electrolyte which is impregnated into the positive electrode, the negative electrode, and the above-described secondary cell separator.

An example of the positive electrode includes a known electrode including a positive electrode collector and a positive electrode active material which is laminated on the positive electrode collector.

Examples of the positive electrode collector include electrically conductive materials such as aluminum, titanium, stainless steel, nickel, calcined carbon, electrically conductive polymers, and electrically conductive glass.

The positive electrode active material is not particularly limited, and examples thereof include known positive electrode active materials such as lithium-containing transition metal oxide, lithium-containing phosphate, and lithium-containing sulfate.

These positive electrode active materials may be used alone or in combination of two or more.

An example of the negative electrode includes a known electrode including a negative electrode collector and a negative electrode active material which is laminated on the negative electrode collector.

Examples of the negative electrode collector include electrically conductive materials such as copper and nickel.

The negative electrode active material is not particularly limited, and examples thereof include carbon active materials. Examples of the carbon active material include graphite, soft carbon, and hard carbon.

These negative electrode active materials may be used alone or in combination of two or more.

When a lithium ion cell is used as the secondary cell, an example of the electrolyte includes a solution in which a lithium salt is dissolved in a carbonate compound such as ethylene carbonate (EC), propylene carbonate (PC), and ethyl methyl carbonate (EMC).

Then, in order to produce the secondary cell, for example, the separator of the secondary cell is sandwiched between the positive electrode and the negative electrode to be housed in a cell casing (cell), and the electrolyte is poured into the cell casing. Thus, the secondary cell can be obtained.

The above-described secondary cell includes the above-described secondary cell separator. Therefore, the heat resistance and the ion permeability are excellent.

### Function and Effect

In the first invention, the ingredient for a secondary cell separator coating material includes the resin which is the reaction product of the modified methylolmelamine condensation resin having the acid group and the polyvinyl alcohol. Therefore, the heat resistance and the ion permeability are excellent.

Specifically, the resin is obtained by using the modified methylolmelamine condensation resin having the acid group having the excellent heat resistance. Therefore, the heat resistance is excellent.

Further, since the resin is obtained by using the polyvinyl alcohol, the wettability is excellent. Therefore, the coating film can be uniformly formed. Then, it is possible to improve the heat resistance and the ion permeability.

Further, since the resin has the excellent wettability, for example, when the ingredient for a secondary cell separator coating material including the resin is coated onto the surface of the porous film, even when the surface of the porous film is not subjected to the surface treatment (for example, corona discharge treatment), it is possible to form the coating film.

When the surface of the porous film is subjected to the surface treatment, the interaction between the ingredient for a secondary cell separator coating material and the porous film is strong, and a part of the ingredient for a secondary cell separator coating material may enter pores of the porous film. Then, the ion permeability may be reduced.

On the other hand, according to the ingredient for a secondary cell separator coating material, even when the surface of the porous film is not subjected to the surface treatment, it is possible to form the coating film. Therefore, it is possible to suppress entry of a part of the ingredient for a secondary cell separator coating material into the pores of the porous film. Then, it is possible to further more improve the ion permeability.

Further, the resin has the excellent storage stability.

Specifically, from the viewpoint of improving the wettability, it is also considered that the modified methylolmelamine is condensed and polymerized in advance to obtain the modified methylolmelamine condensation resin having the acid group, and the polyvinyl alcohol is added to the modified methylolmelamine condensation resin. That is, in such a case, the polyvinyl alcohol is added later.

However, in such a case, when the polyvinyl alcohol is added and then, stored for a certain period of time, it is gelled by the interaction between the hydroxyl group of the polyvinyl alcohol and the methylol group of the modified methylolmelamine resin.

On the other hand, the resin is obtained by dehydrating and condensing the modified methylolmelamine and by reacting the modified methylolmelamine condensation resin having the acid group obtained by the dehydration and condensation with the polyvinyl alcohol in advance. In other words, in such a case, the polyvinyl alcohol is added in advance.

By reacting the modified methylolmelamine condensation resin with the polyvinyl alcohol in advance, it is possible to suppress the above-described gelation. Although the reason is not clear, it is presumed that, by reacting the modified methylolmelamine resin with the polyvinyl alcohol in advance, the hydroxyl group of the polyvinyl alcohol is consumed in the reaction, so that the hydroxyl group of the polyvinyl alcohol is reduced during the storage, and as a result, the storage stability can be improved.

In the second invention, the ingredient for a secondary cell separator coating material includes the modified methylolmelamine condensation resin having the acid group and the polyvinyl alcohol. Therefore, the heat resistance and the ion permeability are excellent.

Specifically, the ingredient for a secondary cell separator coating material includes the modified methylolmelamine condensation resin having the acid group having the excellent heat resistance. Therefore, the heat resistance is excellent.

Further, since the ingredient for a secondary cell separator coating material includes the polyvinyl alcohol, the wettability is excellent. Therefore, it is possible to uniformly form the coating film. Then, it is possible to improve the heat resistance and the ion permeability.

Also, the ingredient for a secondary cell separator coating material has the excellent wettability, even when the surface of the porous film is not subjected to the surface treatment (for example, corona discharge treatment), it is possible to form the coating film.

When the surface of the porous film is subjected to the surface treatment, the interaction between the ingredient for a secondary cell separator coating material and the porous film is strong, and a part of the ingredient for a secondary cell separator coating material may enter the pores of the porous film. Then, the ion permeability may be reduced.

On the other hand, according to the ingredient for a secondary cell separator coating material, even when the surface of the porous film is not subjected to the surface treatment, it is possible to form the coating film. Therefore, it is possible to suppress entry of a part of the ingredient for a secondary cell separator coating material into the pores of the porous film. Then, it is possible to further more improve the ion permeability.

The secondary cell separator coating material includes the above-described ingredient for a secondary cell separator coating material. Therefore, the heat resistance and the ion permeability are excellent.

The secondary cell separator includes the coating film of the above-described secondary cell separator coating material. Therefore, the heat resistance and the ion permeability are excellent.

The secondary cell includes the above-described secondary cell separator. Therefore, the heat resistance and the ion permeability are excellent.

### EXAMPLES

The specific numerical values in mixing ratio (content ratio), property value, and parameter used in the following description can be replaced with upper limit values (numerical values defined as “or less” or “below”) or lower limit values (numerical values defined as “or more” or “above”) of corresponding numerical values in mixing ratio (content ratio), property value, and parameter described in the above-described “DESCRIPTION OF EMBODIMENTS”. All designations of “part” or “parts” and “%” mean part or parts by mass and % by mass, respectively, unless otherwise particularly specified.

### <Details of Components>

Trade names and abbreviations of each of the components used in Examples and Comparative Examples are described in detail.
AF 17: carboxyl group-modified polyvinyl alcohol, saponification degree of above 96 mol %, manufactured by JAPAN VAM& POVAL CO., LTD.
GOHSENX CKS-50: sulfo group-modified polyvinyl alcohol, saponification degree of 99 mol %, manufactured by Mitsubishi Chemical Corporation
GOHSENX WO-320: hydrophilic group-modified polyvinyl alcohol, saponification degree of 98.5 mol %, manufactured by Mitsubishi Chemical Corporation
Kuraray Poval 5-98: unmodified polyvinyl alcohol, saponification degree of 98 mol % to 99 mol %, manufactured by KURARAY Co., Ltd.
Kuraray Poval 60-98: unmodified polyvinyl alcohol, saponification degree of 98 mol % to 99 mol %, manufactured by KURARAY Co., Ltd.
Kuraray Poval 44-88: unmodified polyvinyl alcohol, saponification degree of 87 mol % to 89 mol %, manufactured by KURARAY Co., Ltd.
Kuraray Poval 5-74: unmodified polyvinyl alcohol, saponification degree of 72.5 mol % to 74.5 mol %; manufactured by KURARAY Co., Ltd.
Wetting agent: acetylene-based surfactant, OLFINE E1010, manufactured by Nissin Chemical co., ltd.
Ammonium polycarboxylate: dispersant, aqueous solution of ammonium polycarboxylate, trade name: SN5468, manufactured by SAN NOPCO LIMITED

### <<First Invention>>

### <Preparation of Aqueous Solution of Polyvinyl Alcohol>

A separable flask equipped with a stirrer was charged with 100 parts by mass of water, and 10 parts by mass of each polyvinyl alcohol (AF17, GOHSENX CKS-50, GOHSENX WO-320, and Kuraray Poval 5-98) was gradually added thereto, while stirring, and the temperature of the mixture was increased to 95° C. and held for five hours. After confirming that the polyvinyl alcohol was completely dissolved, it was cooled and an appropriate amount of water was added, thereby preparing the aqueous solution of 10% polyvinyl alcohol for each polyvinyl alcohol.

### <Production of Resin>

### Production Example 1

A four-necked flask equipped with a stirrer, a thermometer, and a reflux tube was charged with 33.0 parts by mass of water and 114.8 parts by mass of 37% formaldehyde, and the charged mixture was stirred and mixed. Further, 51 parts by mass of melamine was added thereto while stirring. Next, the temperature of the mixture was increased to 60° C., and the pH thereof was adjusted to 11.0 with the aqueous solution of 40% sodium hydroxide. Thereafter, it was further reacted at 67° C. for two hours to be cooled to 50° C. Thus, the methylolmelamine was obtained.

Next, 32 parts by mass of sodium bisulfite was added to the obtained methylolmelamine, and the pH thereof was adjusted to 11.5 with the aqueous solution of 40% sodium hydroxide to be reacted at 80° C. for four hours. Thus, the modified methylolmelamine was obtained. Next, 150 parts by mass of the aqueous solution of AF17 (10%) and 342 parts by mass of water were added thereto, and thereafter, the pH thereof was adjusted to 6.6 with 40% sulfuric acid to be reacted at 72° C. for eight hours. Thereafter, the reaction was stopped by adjusting the pH to 12.0 with the aqueous solution of 25% sodium hydroxide. Thereafter, the water was added thereto at an appropriate amount. Thus, the resin (aqueous solution of the resin) (solid content concentration of 16% by mass) was obtained.

### Production Example 2 to Production Example 4

The resin (aqueous solution of the resin) (solid content concentration of 16% by mass) was obtained based on the same manner as Production Example 1. However, the formulation of each of the components was changed in accordance with Table 1. Numerical values described in Table 1 are parts by mass (solid content).

### Comparative Production Example 1

The separable flask equipped with the stirrer and the reflux condenser was charged with 200.0 parts by mass of distilled water to be replaced with nitrogen gas, and then, the charged water was heated to 80° C. Next, 0.6 parts by mass of ammonium persulfate was added, and thereafter, the following monomer composition was continuously added over three hours. Further, the monomer composition was held furthermore three hours to complete the polymerization. Ammonia water was added thereto, and the pH thereof was adjusted to 9.0, and next, an appropriate amount of water was added, thereby obtaining the aqueous solution of the water-soluble polymer having the solid content of 16.0%.

### [Monomer Composition]

| | | |
|---|---|---|
| Methacrylamide | 95.0 | parts by mass |
| Methacrylic acid | 5.0 | parts by mass |
| 25% ammonia water | 5.0 | parts by mass |
| Distilled water | 300.0 | parts by mass |

### Reference Production Example 1

The four-necked flask equipped with the stirrer, the thermometer, and the reflux tube was charged with 692.0 parts by mass of water and 277.8 parts by mass of 37% formaldehyde, and the charged mixture was stirred and mixed. Further, 144.0 parts of melamine was added thereto while stirring. Next, the temperature of the obtained mixture was increased to 60° C., and the pH thereof was adjusted to 11.0 with the aqueous solution of 25% sodium hydroxide. Thereafter, it was further reacted at 75° C. for three hours to be cooled to 60° C. Thus, the methylolmelamine was obtained.

Next, as the acid component, 50.9 parts by mass of sodium bisulfite was added to the obtained methylolmelamine to be reacted at 80° C. for two hours. Thus, the modified methylolmelamine was obtained.

Next, after the modified methylolmelamine was cooled to 40° C. or less, the water was added thereto, thereby adjusting the solid content concentration to 20% by mass. Further, the pH thereof was adjusted to 6.8 with 40% sulfuric acid to be condensed at 70° C. for three hours. Thereafter, the pH thereof was adjusted to 12.0 with the aqueous solution of 25% sodium hydroxide to stop the reaction. Next, an appropriate amount of water was added, thereby obtaining the resin (aqueous solution of the resin) (solid content concentration of 18% by mass).

### <Production of Ingredient for Secondary Cell Separator Coating Material, Secondary Cell Separator Coating Material, and Secondary Cell Separator>

### Example 1

### (Production of Ingredient for Secondary Cell Separator Coating Material)

The resin of Production Example 1 was used as the ingredient for a secondary cell separator coating material.

### (Production of Secondary Cell Separator Coating Material)

A dispersant was added to 123 parts by mass of water in accordance with the formulation described in Table 2. Next, as the inorganic particles, 100 parts by mass of boehmite (aluminum hydroxide oxide, manufactured by Nabaltec AG, trade name “APYRAL AOH60”, average median diameter D50:0.9 μm) was gradually added, while stirring with a disper (1000 rpm). After the adding, it was further stirred with a homogenizer (5000 rpm). Thus, the aqueous dispersion liquid of the inorganic particles (solid content concentration of the inorganic particles of 45% by mass) was obtained.

Next, the ingredient for a secondary cell separator coating material was blended into the aqueous dispersion liquid of the inorganic particles, and the water was appropriately added and stirred.

Thereafter, the obtained mixture was filtered through a 300-mesh filter (filtered particle size of 48 μm). Thus, the secondary cell separator coating material (dispersion liquid of the secondary cell separator coating material) was produced. The solid content concentration of the dispersion liquid of the secondary cell separator coating material was 40% by mass.

### (Production of Secondary Cell Separator)

### [First Step]

As the porous film, a polyolefin porous film (without the surface treatment (corona treatment)) was prepared.

### [Second Step]

The above-described secondary cell separator coating material (dispersion liquid of the secondary cell separator coating material) was coated onto one surface of the polyolefin porous film using a wire bar. Thereafter, the obtained coated product was dried at 50° C. Thus, the coating film (thickness of 4 μm and thickness of 2 μm) of the secondary cell separator coating material was formed on one surface of the polyolefin porous film. Thus, the secondary cell separator was produced.

### Example 2 to Example 4, Comparative Example 1 and Reference Example 1

The ingredient for a secondary cell separator coating material, the secondary cell separator coating material, and the secondary cell separator were obtained based on the same manner as that of Example 1. The formulation of each of the components was changed in accordance with Table 2. The numerical values described in Table 2 are parts by mass (solid content). In addition, in Comparative Example 1, the aqueous solution of the water-soluble polymer of Production Comparative Example 1 as the ingredient for a secondary cell separator coating material, and E1010 were blended, thereby producing the secondary cell separator coating material. In addition, in Reference Example 1, the resin of Production Reference Example 1 as the ingredient for a secondary cell separator coating material and the aqueous solution (10%) of AF were blended, thereby producing the secondary cell separator coating material.

### <Evaluation>

### [Heat Resistance]

Each of the secondary cell separators of Examples, Comparative Examples, and Reference Examples was cut into pieces having a size of 5 cm×5 cm to be used as test pieces. After the test pieces were left to stand in an oven at 150° C. for one hour. The length of each side of the test pieces was measured before and after being left. A shrinkage rate was calculated from the length of each side before and after the shrinkage based on the following formula (1). The results are shown in Table 2.

$$Amount of change in viscosity = ( viscosity after storage at 40 °C . for one month - viscosity immediately after polymerization ) / viscosity immediately after polymerization \qquad ( 3 )$$

### [Ion Permeability]

The air permeability resistance of each of the secondary cell separators of Examples, Comparative Examples, and Reference Examples was obtained by measurement in conformity with JIS-P-8117 with an Oken-type air permeability-smoothness tester manufactured by ASAHI SEIKO CO., LTD. An amount of decrease in the air permeability with respect to the air permeability of the porous film itself was referred to as A air permeability. Specifically, A air permeability was calculated based on the following formula (2). It was evaluated that the smaller the Δ air permeability was, the more excellent the ion permeability was. The results are shown in Table 2.

$$Shrinkage rate ( \% ) = \{ average length of one side before shrinkage ( cm ) - average length of one side after shrinkage ( cm ) \} / average length of one side before shrinkage ( cm ) \times 100 \qquad ( 1 )$$

### [Storage Stability]

As for each of the resins of Production Examples and Production Reference Examples, and the aqueous solution of the water-soluble polymer of Comparative Example 1, an amount of change in viscosity at the time of storage at 40° C. for one month was measured. The viscosity was measured using a VISCOMETER manufactured by Toki Sangyo Co., Ltd. at 60 rpm at 25° C. Further, the amount of change in viscosity was calculated based on the following formula (3). The results are shown in Table 2.

$$Δ air permeability = measured air permeability - 180 ( air permeability of porous film itself ) \qquad ( 2 )$$

### <Consideration>

It was found that Example 1 to Example 4 using the resin which was the reaction product of the modified methylolmelamine condensation resin having the acid group and the polyvinyl alcohol have the more excellent heat resistance than Comparative Example 1 using an acrylic water-soluble polymer.

It was found that Example 1 to Example 4 in which the polyvinyl alcohol was added in advance have the more excellent storage stability than Reference Example 1 in which the polyvinyl alcohol was added later.

### <<Second Invention>>

### <Production of Modified Methylolmelamine Condensation Resin Having Acid Group>Production Example 5

The four-necked flask equipped with the stirrer, the thermometer, and the reflux tube was charged with 692.0 parts by mass of water and 277.8 parts by mass (3.43 mol) of 37% formaldehyde, and the charged mixture was stirred and mixed. Further, 144.0 parts by mass (1.14 mol) of melamine was added thereto while stirring. Next, the temperature of the mixture was increased to 60° C., and the pH thereof was adjusted to 11.0 with the aqueous solution of 25% sodium hydroxide. Thereafter, it was further reacted at 75° C. for three hours to be cooled to 60° C. Thus, the methylolmelamine was obtained.

Next, as the acid component, 50.9 parts by mass (0.489 mol) of sodium bisulfite was added to the obtained methylolmelamine to be reacted at 80° C. for two hours. Thus, the modified methylolmelamine was obtained.

Next, after the modified methylolmelamine was cooled to 40° C. or less, the water was added thereto, thereby adjusting the solid content concentration to 20% by mass. Further, the pH thereof was adjusted to 6.8 with the 40% sulfuric acid to be condensed at 70° C. for three hours. Thereafter, the pH thereof was adjusted to 12.0 with the aqueous solution of 25% sodium hydroxide to stop the reaction. Thus, the modified methylolmelamine condensation resin (aqueous dispersion liquid of the modified methylolmelamine condensation resin) was obtained. Next, an appropriate amount of water was added, thereby adjusting the solid content concentration of the aqueous dispersion liquid of the modified methylolmelamine condensation resin to 18% by mass.

### Production Example 6

The four-necked flask equipped with the stirrer, the thermometer, and the reflux tube was charged with 692.0 parts by mass of water and 259.3 parts by mass (3.20 mol) of 37% formaldehyde, and the charged mixture was stirred and mixed. Further, 144.0 parts by mass (1.14 mol) of melamine was added thereto while stirring. Next, the temperature of the mixture was increased to 60° C., and the pH thereof was adjusted to 11.0 with the aqueous solution of 25% sodium hydroxide. Thereafter, it was further reacted at 75° C. for three hours to be cooled to 60° C. Thus, the methylolmelamine was obtained.

Next, as the acid component, 33.9 parts by mass (0.426 mol) of sodium bisulfite was added to the obtained methylolmelamine to be reacted at 80° C. for two hours. Thus, the modified methylolmelamine was obtained.

Next, after the modified methylolmelamine was cooled to 40° C. or less, the water was added thereto, thereby adjusting the solid content concentration to 20% by mass. Further, the pH thereof was adjusted to 6.8 with the 40% sulfuric acid to be condensed at 70° C. for three hours. Thereafter, the pH thereof was adjusted to 12.0 with the aqueous solution of 25% sodium hydroxide to stop the reaction. Thus, the modified methylolmelamine condensation resin (aqueous dispersion liquid of the modified methylolmelamine condensation resin) was obtained. Next, an appropriate amount of water was added, thereby adjusting the solid content concentration of the aqueous dispersion liquid of the modified methylolmelamine condensation resin to 18% by mass.

### <Production of Acrylic Water-Soluble Polymer>

### Production Example 7

The separable flask equipped with the stirrer and the reflux condenser was charged with 200.0 parts by mass of distilled water to be replaced with the nitrogen gas, and then, the charged water was heated to 80° C. Next, 0.6 parts by mass of ammonium persulfate was added, and thereafter, the following monomer composition was continuously added over three hours. Further, the monomer composition was held furthermore three hours to complete the polymerization. The ammonia water was added thereto, and the pH thereof was adjusted to 9.0, and next, an appropriate amount of water was further added, thereby obtaining the aqueous solution of the water-soluble polymer having the solid content of 20.0%.

### [Monomer Composition]

| | | |
|---|---|---|
| Methacrylamide | 95.0 | parts by mass |
| Methacrylic acid | 5.0 | parts by mass |
| 25% ammonia water | 5.0 | parts by mass |
| Distilled water | 300.0 | parts by mass |

### <Preparation of Polyvinyl Alcohol>

Each polyvinyl alcohol (Kuraray Poval 60-98, AF17, Kuraray Poval 44-88, Kuraray Poval 5-74) was prepared as follows. Specifically, the separable flask equipped with the stirrer was charged with 100 parts by mass of water, and 10 parts by mass of polyvinyl alcohol was gradually added thereto while stirring. Thereafter, the temperature of the mixture was increased to 95° C. to be held for three hours. After confirming that the polyvinyl alcohol was completely dissolved, it was cooled and an appropriate amount of water was added thereto, thereby preparing a 10% aqueous solution of the polyvinyl alcohol.

### <Production of Ingredient for Secondary Cell Separator Coating Material, Secondary Cell Separator Coating Material, and Secondary Cell Separator>

### Example 5 to Example 11 and Comparative Example 2 to Comparative Example 4

### (Production of Ingredient for Secondary Cell Separator Coating Material)

The modified methylolmelamine condensation resin having the acid group and the polyvinyl alcohol were separately prepared in accordance with the formulation described in Table 3. Thus, the ingredient for a secondary cell separator coating material was produced. Further, in Comparative Example 4, the acrylic water-soluble polymer was used instead of the modified methylolmelamine condensation resin having the acid group. The numerical values described in Table 3 are the numerical values of the solid content.

### (Production of Secondary Cell Separator Coating Material)

The dispersant was added to 123 parts by mass of water in accordance with the formulation described in Table 3. Next, as the inorganic particles, 100 parts by mass of boehmite (aluminum hydroxide oxide, manufactured by Nabaltec AG, trade name “APYRAL AOH60”, average median diameter D50:0.9 μm) was gradually added, while being stirred with the disper (1000 rpm). After the adding, it was further stirred with the homogenizer (5000 rpm). Thus, the aqueous dispersion liquid of the inorganic particles (solid content concentration of the inorganic particles of 45% by mass) was obtained.

Next, the ingredient for a secondary cell separator coating material was blended into the aqueous dispersion liquid of the inorganic particles (specifically, the modified methylolmelamine condensation resin having the acid group (or the acrylic water-soluble polymer) and the polyvinyl alcohol which were separately prepared were mixed and blended), and the water was appropriately added and stirred.

Thereafter, the obtained mixture was filtered through the 300-mesh filter (filtered particle size of 48 μm). Thus, the secondary cell separator coating material (dispersion liquid of the secondary cell separator coating material) was produced. The solid content concentration of the dispersion liquid of the secondary cell separator coating material was 40% by mass.

### (Production of Secondary Cell Separator)

### [First Step]

As the porous film, the polyolefin porous film (without the surface treatment (corona treatment)) was prepared.

### [Second Step]

The above-described secondary cell separator coating material (dispersion liquid of the secondary cell separator coating material) was coated onto one surface of the polyolefin porous film using the wire bar. Thereafter, the obtained coated product was dried at 50° C. Thus, the coating film (thickness of 4 μm) of the secondary cell separator coating material was formed on one surface of the polyolefin porous film. Thus, the secondary cell separator was produced.

### <Evaluation>

### [Heat Resistance]

The heat resistance was evaluated in the same manner as the first invention. The results are shown in Table 3.

### [Ion Permeability]

The ion permeability was evaluated in the same manner as the first invention. The results are shown in Table 3.

### <Consideration>

It was found that Example 5 to Example 11 including the modified methylolmelamine condensation resin having the acid group and the polyvinyl alcohol have the more excellent heat resistance and the more excellent ion permeability than Comparative Example 2 without the polyvinyl alcohol, and Comparative Example 3 and Comparative Example 4 without the modified methylolmelamine condensation resin having the acid group.

TABLE 1

| | | | | | | | Production |
|---|---|---|---|---|---|---|---|
| Production Ex.•Production | | | Production | Production | Production | Production | Reference |
| Reference Ex. No. | | | Ex. 1 | Ex. 2 | Ex. 3 | Ex. 4 | Ex. 1 |
| Resin | Formaldehyde | | 42.476 | 42.476 | 42.476 | 42.476 | 102.786 |
| | Melamine | | 51 | 51 | 51 | 51 | 144.0 |
| | Acid | Sodium | 32 | 32 | 32 | 32 | 50.9 |
| | Component | Bisulfite | | | | | |
| | Polyvinyl | AF17 | 15 | — | — | — | — |
| | Alcohol | GOHSENX | — | 15 | — | — | — |
| | | CKS-50 | | | | | |
| | | GOHSENX | — | — | 15 | — | — |
| | | WO-320 | | | | | |
| | | Kuraray | — | — | — | 15 | — |
| | | Poval 5-98 | | | | | |

| | | | | | |
|---|---|---|---|---|---|
| Mixing Amount of | 3.5 | 3.5 | 3.5 | 3.5 | 3 |
| Formaldehyde to 1 mol of | | | | | |
| Melamine (mol) | | | | | |
| Mixing Amount of Acid | 0.75 | 0.75 | 0.75 | 0.75 | 0.43 |
| Component to 1 mol of | | | | | |
| Methylolmelamine (mol) | | | | | |

TABLE 2

| | | | | | | | | Comparative | Reference |
|---|---|---|---|---|---|---|---|---|---|
| Ex.•Comparative Ex.•Reference Ex. No. | | | | Ex. 1 | Ex. 2 | Ex. 3 | Ex. 4 | Ex. 1 | Ex. 1 |
| Secondary | Resin | Production Ex. 1 | | 5 | — | — | — | — | — |
| Cell | | Production Ex. 2 | | — | 5 | — | — | — | — |
| Separator | | Production Ex. 3 | | — | — | 5 | — | — | — |
| Coating | | Production Ex. 4 | | — | — | — | 5 | — | — |
| Material | | Production Comparative Ex. 1 | | — | — | — | — | 4 | — |
| | | Production Reference Ex. 1 | | — | — | — | — | — | 4 |
| | Inorganic | Aluminum Hydroxide Oxide | | 100 | 100 | 100 | 100 | 100 | 100 |
| | Particles | | | | | | | | |
| | Additive | Dispersant | Ammonium | 1 | 1 | 1 | 1 | 1 | 1 |
| | | | Polycarboxylate | | | | | | |
| | | Wetting Agent | E1010 | — | — | — | — | 0.6 | — |
| | | Polyvinyl | AF17 | — | — | — | — | — | 0.6 |
| | | Alcohol | | | | | | | |
| Evaluation | Heat | Shrinkage | 2 μm | 22 | 21 | 25 | 25 | 80 | 22 |
| | Resistance | Rate (%) | 4 μm | 7 | 9 | 12 | 9 | 22 | 13 |
| | Ion | Δ Air | 2 μm | 20 | 20 | 30 | 30 | 40 | 20 |
| | Permeability | Permeability | 4 μm | 25 | 30 | 40 | 35 | 80 | 30 |
| | | (s/100 ml) | | | | | | | |
| | Storage | Amount of change in viscosity | | 0.2 | 0.2 | 0.1 | 0.2 | −0.7 | Infinity |
| | Stability | | | | | | | | (Gelation |
| | | | | | | | | | in 3 days) |

TABLE 3

| | | | | | Comp. Ex. | Comp. Ex. | Comp. Ex. | | |
|---|---|---|---|---|---|---|---|---|---|
| Ex.•Comparative Ex. | | | | | 2 | 3 | 4 | Ex. 5 | Ex. 6 |
| Secondary | Ingredient | Modified Methylolmelamine | | Production Ex. 5 | 4 | — | — | 4 | 4 |
| Cell | for Secondary | Condensation Resin Having Acid | | Production Ex. 6 | — | — | — | — | — |
| Separator | Cell | Group | | | | | | | |
| Coating | Separator | Acrylic Water-Soluble Polymer | | Production Ex. 7 | — | — | 4 | — | — |
| Material | Coating | Polyvinyl | Unmodified | Kuraray Poval 60-98 | — | 4.6 | — | — | 0.6 |
| Evaluation | Material | Alcohol | Polyvinyl | Kuraray Poval 44-88 | — | — | — | — | — |
| | | | Alcohol | Kuraray Poval 5-74 | — | — | — | — | — |
| | | | Carboxyl | AF17 | — | — | — | 0.6 | — |
| | | | Group- | | | | | | |
| | | | Modified | | | | | | |
| | | | Polyvinyl | | | | | | |
| | | | Alcohol | | | | | | |

| | | | | | | |
|---|---|---|---|---|---|---|
| Wetting Agent | E1010 | 0.6 | — | 0.6 | — | — |

| | | | | | |
|---|---|---|---|---|---|
| Content Ratio of Polyvinyl Alcohol to 100 | 15 | — | — | 15 | 15 |
| parts by mass of Modified Methylolmelamine | | | | | |
| Condensation Resin Having Acid Group (parts by mass) | | | | | |

| | | | | | | | |
|---|---|---|---|---|---|---|---|
| | Inorganic Particles | Aluminum Hydroxide | 100 | 100 | 100 | 100 | 100 |
| | | Oxide | | | | | |
| | Dispersant | Ammonium | 1 | 1 | 1 | 1 | 1 |
| | | Polycarboxylate | | | | | |
| Evaluation | Heat Resistance | Shrinkage Rate (%) | 30 | 25 | 40 | 13 | 13 |
| | Ion Permeability | Δ Air Permeability | 75 | 300 | 75 | 30 | 35 |

| Ex.•Comparative Ex. | | | | | Ex. 7 | Ex. 8 | Ex. 9 | Ex. 10 | Ex. 11 |
|---|---|---|---|---|---|---|---|---|---|
| Secondary | Ingredient | Modified Methylolmelamine | | Production Ex. 5 | — | 4 | 4 | 4 | 4 |
| Cell | for Secondary | Condensation Resin Having Acid | | Production Ex. 6 | 4 | — | — | — | — |
| Separator | Cell | Group | | | | | | | |
| Coating | Separator | Acrylic Water-Soluble Polymer | | Production Ex. 7 | — | — | — | — | — |
| Material | Coating | Polyvinyl | Unmodified | Kuraray Poval 60-98 | — | — | — | — | — |
| Evaluation | Material | Alcohol | Polyvinyl | Kuraray Poval 44-88 | 0.6 | — | — | — | — |
| | | | Alcohol | Kuraray Poval 5-74 | — | 0.6 | — | — | — |
| | | | Carboxyl | AF17 | — | — | 0.2 | 2.0 | 1.6 |
| | | | Group- | | | | | | |
| | | | Modified | | | | | | |
| | | | Polyvinyl | | | | | | |
| | | | Alcohol | | | | | | |

| | | | | | | |
|---|---|---|---|---|---|---|
| Wetting Agent | E1010 | — | — | — | — | — |

| | | | | | |
|---|---|---|---|---|---|
| Content Ratio of Polyvinyl Alcohol to 100 | 15 | 15 | 5 | 50 | 4 |
| parts by mass of Modified Methylolmelamine | | | | | |
| Condensation Resin Having Acid Group (parts by mass) | | | | | |

| | | | | | | | |
|---|---|---|---|---|---|---|---|
| | Inorganic Particles | Aluminum Hydroxide | 100 | 100 | 100 | 100 | 100 |
| | | Oxide | | | | | |
| | Dispersant | Ammonium | 1 | 1 | 1 | 1 | 1 |
| | | Polycarboxylate | | | | | |
| Evaluation | Heat Resistance | Shrinkage Rate (%) | 14 | 13 | 10 | 13 | 21 |
| | Ion Permeability | Δ Air Permeability | 45 | 75 | 20 | 75 | 18 |

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICATION

The ingredient for a secondary cell separator coating material, the secondary cell separator coating material, and the secondary cell separator of the present invention are preferably used in the production of a secondary cell.

1. An ingredient for a secondary cell separator coating material comprising:
a resin being a reaction product of a modified methylolmelamine condensation resin having an acid group and polyvinyl alcohol, or
the modified methylolmelamine condensation resin having the acid group and the polyvinyl alcohol.

2. The ingredient for a secondary cell separator coating material according to claim 1 comprising:
the resin, wherein
the acid group is a sulfonic acid group.

3. The ingredient for a secondary cell separator coating material according to claim 1 comprising:
the modified methylolmelamine condensation resin having the acid group and the polyvinyl alcohol, wherein
a content ratio of the polyvinyl alcohol is 5 parts by mass or more and below 50 parts by mass with respect to 100 parts by mass of the modified methylolmelamine condensation resin.

4. A secondary cell separator coating material comprising:
the ingredient for a secondary cell separator coating material according to claim 1 and inorganic particles.

5. A secondary cell separator comprising:
a porous film and
a coating film of the secondary cell separator coating material according to claim 4 disposed on at least one surface of the porous film.

6. A secondary cell comprising:
a positive electrode, a negative electrode, and the secondary cell separator according to claim 5 disposed between the positive electrode and the negative electrode.
